(19) United States
(12) Patent Application Publication
(10) Pub. No.: US 2003/0148758 A1
(43) Pub. Date: Aug. 7, 2003

(54) Wireless telephone call manager

(76) Inventor: William P. McMullin, Nova Scotia (CA)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/221,784

(22) PCT Filed: Mar. 21, 2001
(86) PCT No.: PCT/CA01/00368

(51) Int. Cl. H04M 3/42

(52) U.S. Cl. 455/415; 455/461

(57) ABSTRACT

Methods and apparatus are disclosed for providing automatic redirection of an incoming voice telephone call from a caller to a subscriber proxy when an attempt by the caller to connect to a subscribers mobile/wireless/cellular telephone is blocked due to either having the mobile phone off, on but not answered, or in use. The subscriber has further established communications between a subscriber's data communication terminal (DCT) (e.g. PC, Internet appliance, Palm™ handheld etc.) a computer network (e.g. the Internet). The subscriber proxy is connected to both the PSTN, CMTS and the Internet, and produces audio interaction with the caller. The subscriber proxy also notifies the subscriber of the incoming call via the subscriber's DCT. The subscriber's DCT can optionally be used by the subscriber to control and interact with the incoming call by communicating with the computer proxy while the subscriber continues to maintain the Internet connection.

### TECHNICAL FIELD

The present invention relates to the field of wireless telephone call management using a computer network such as the Internet.

### BACKGROUND ART

Monitoring and management of calls on a wireless telephone are currently limited to voice mail or call forwarding type functions. Wireless phones include (a) analog cellular that operates in the 800 MHz frequency range using the Advanced Mobile Phone Service (AMPS) air interface; (b) digital cellular that shares the 800 MHz frequency band with analog using either the Code Division Multiple Access (CDMA) or the Time Division Multiple Access (TDMA) air interface; (c) Personal Communications Service (PCS), which is an all-digital service that operates in the 1,900 MHz frequency range, using CDMA, TDMA or global system for mobile communications (GSM); and (d) tri-mode that operate on PCS, digital cellular and analog cellular networks.

A user can currently establish a connection to a computer/data network (i.e. the Internet) through an Internet Access/Service Provider (IAP,ISP) using a data communications terminal (e.g. computer, Internet appliance, hand-held etc.) through a regular telephone line, wireless connection, or on a dedicated connection such as Digital Subscriber Line (DSL) or a T-1 line.

There is a need for a system and method that enables wireless telephone users to monitor and manage their wireless telephone calls using the Internet.

### DISCLOSURE OF THE INVENTION

It is an object of the present invention to provide a method for providing call notification over a network for calls destined to a wireless telephone.

Another object of the present invention is to provide wireless telephone users with the ability to monitor and manage calls through a data network.

In accordance with one aspect of the present invention there is provided a call management method for providing notification of calls, destined for a wireless telephone, over a data communications network having a call management proxy having a database of subscribers in communication with the data communications network, the method comprising the steps of: connecting a data communications terminal (DCT) to a network; providing a data network address of the DCT to the call management proxy; and notifying the DCT when an incoming call is detected on the wireless telephone.

In accordance with another aspect of the present invention there is provided a call management method for providing notification of calls, destined for a wireless telephone, over a data communications network having a call management proxy, which contains a database of wireless telephone subscribers, in communication with the data communications network, the method comprising the steps of: enabling connection of a data communications terminal (DCT) to a network; requesting a data network address of the DCT to the call management proxy; and (c) providing notification to the DCT when an incoming call is detected on the wireless telephone.

In accordance with another aspect of the present invention there is provided A call management method for providing notification of calls, destined for a wireless telephone, in a public switched telephone network (PSTN) and cellular mobile telephone system (CMTS) environment over a data communications network having a call management proxy, which includes a database of wireless telephone subscribers, connected to the PSTN and the CMTS, the method comprising the steps of: receiving a message over the data communications network containing a subscriber dial number linked to the wireless telephone and a unique data network address; storing the subscriber dial number and the unique data network address; receiving a telephone call forwarded by the CMTS; obtaining dialed number information from the CMTS; comparing the dialed number information to the stored subscriber dial number information; and for matching number information, providing a call waiting message to said data network addressed to said unique data network address corresponding to the dialed number information.

### BRIEF DESCRIPTION OF DRAWINGS

Exemplary embodiments of the invention will now be described in conjunction with the attached drawings, in which:

FIG. 1 is a schematic block diagram illustrating the physical components and telecommunications network that are used to support the preferred methods and processes of the present invention;

FIG 2. is a functional block diagram illustrating the logical elements of a preferred embodiment of the system of the present invention;

FIG. 3 is a flowchart showing an incoming caller handling process;

FIG. 4 is a flowchart showing a no answer handler process; and

FIG. 5 is a flowchart showing a caller handler process where the called subscriber is occupying the telephone link on a data network call.

### BEST MODE FOR CARRYING OUT THE INVENTION

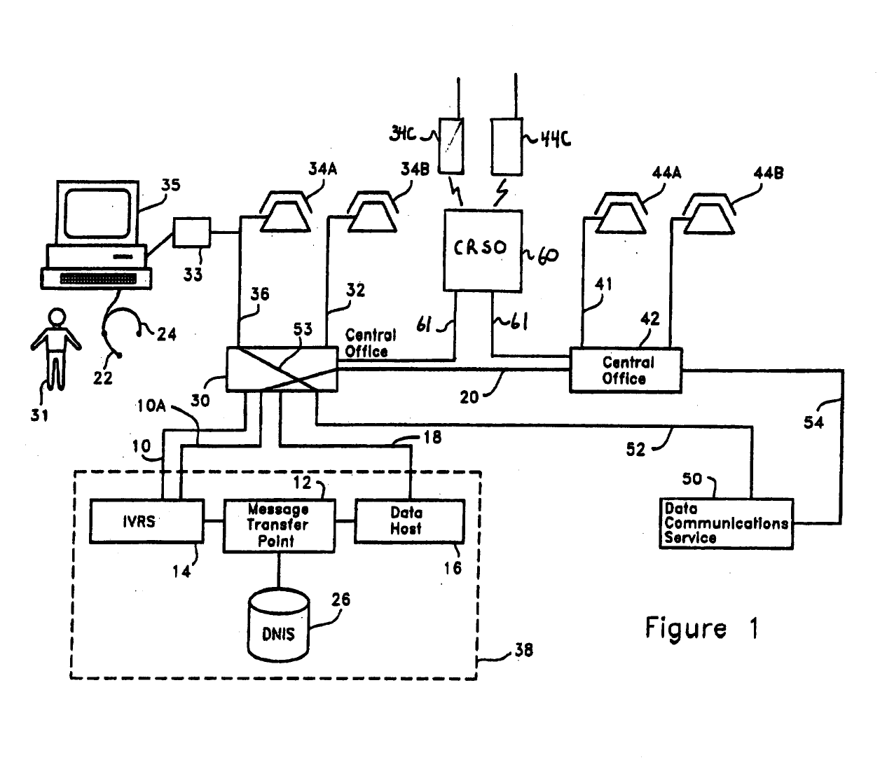

FIG. 1 illustrates a telecommunications system including local exchange central offices (COs) 30 and 42 connected by a trunk 20 and a cellular radio switching office (CRSO) 60, which interfaces with the COs 30 and 42 over links 61. The central offices 30 and 42 support a plurality of subscribers each subscriber having a telephone link associated with telephones 34A, 34B, 34C (wireless) 44A, 44B, 44C (wireless), such links are shown at 32, 36 and 41. A modem 33 is also in communication with the CO 30 over telephone link 36. The central offices 30 and 42 also support dedicated communications channels such as 18 and 54. The central offices 30 and 42 may consist, for example, of telecommunications switches such as a Nortel Networks DMS-100™ or AT&T 5ESS™ switch.

An Interactive Voice Response System (IVRS) 14 is coupled to CO 30 through telephone link 10. The IVRS 14 includes audio playback and record capabilities permitting recorded voice messages to be delivered to a caller's telephone 44A or 44C and to collect and store touch-tone entries made by callers using such telephones.

The switch of CO 30 is connected to the IVRS 14 by telephone link 10. The telephone link 10 has an associated signaling channel 10A. The signaling channel 10A is provided to communicate a called number to the IVRS 14 to enable the IVRS to customize the interaction it has to relate to the subscriber line that the call was transferred from.

There are several options for delivery of the called number to the IVRS 14. The called number information could be delivered during call setup by way of the Integrated Services Digital Network call setup signaling. For POTS telephone or centrex, the called number information could be provided using the Simplified Message Desk Interface (SMDI). Other options are available using the Advanced Intelligent Network interface. Any of these options may be advantageously employed by one skilled in the art to obtain delivery of the called number to carry out the process of the present invention.

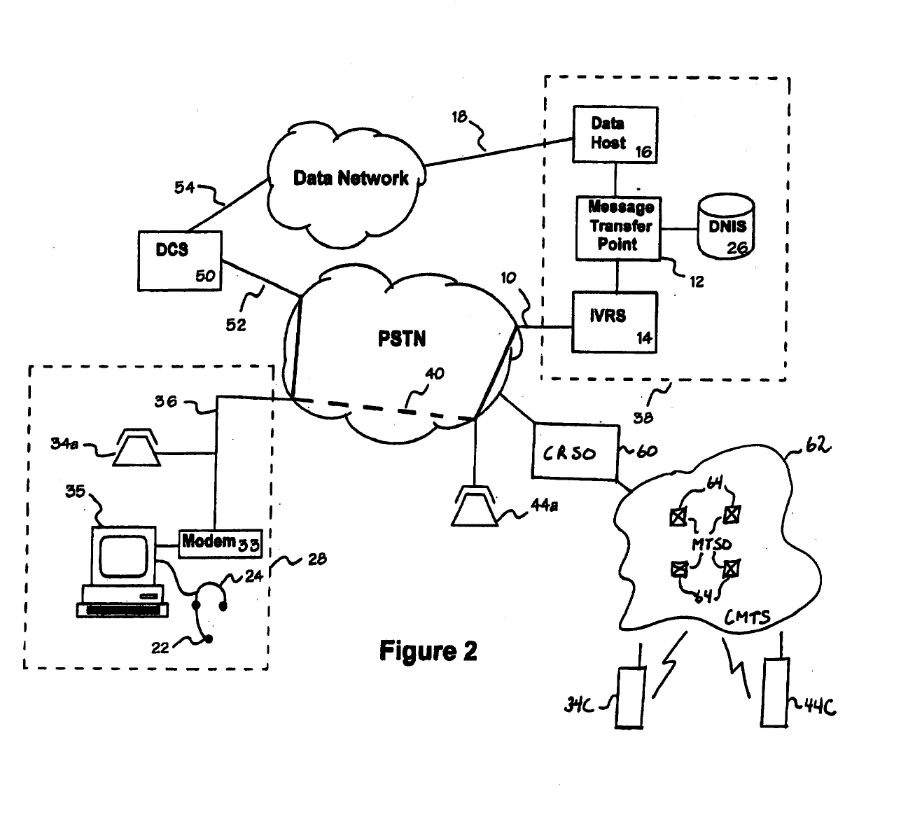

The DH 16 is in communication with the data network as shown in FIG. 2. A particular connection topography is shown in FIG. 1 where the CO 30 is connected to the Data Host (DH) 16 using channel 18 and to the Data Communications Service (DCS) 50 over telephone link 52. The switch of central office 42 is connected to the DCS by dedicated communications channel 54.

A Message Transfer Point (MTP) 12 is directly connected to the IVRS 14 and the DH 16 and functions as an intermediary by translating and transferring messages between the DH 16 and the IVRS 14. The MTP 12 accesses subscriber records from customer record file 26 which contains records for subscribers that are authorized to use the service. In addition, each subscriber's DNIS (Dialed Number Identification Service) record contains real-time subscriber information relating to the status of the subscriber's telephone link (for example, link 36). Each subscriber link has a real-time record stored in the data store accessed by the MTP 12 so in the event a message or call is received by the IVRS 14 the MTP 12 can control the manner in which the IVRS 14 processes the message or call according to the status of the subscriber telephone link 36.

DH 16 is a computer host with a dedicated communications link to the DCS 50 through the CO 30, which is coupled to the CO 42 that has a dedicated communications channel 54 to the DCS. The dedicated link allows the DH 16 and the DCS 50 to communicate by providing a continuous communications path.

The DCS 50, through a data channel such as telephone link 52 also allows a subscriber using a dial-up data channel such as telephone link 36 to establish temporary dial-up data connections to the DCS 50, over the PSTN. Block 38 is generically referred to as a call management proxy.

The subscriber's wireless/mobile (terms used interchangeably) telephone 34C (cellular-digital, analog, PCS, tri-mode) communicates to a cellular mobile telephone system (CMTS) 62, consisting of a plurality of mobile telephone switching offices (MTSO) 64. The MTSO 64 communicates with the cellular radio switching office (CRSO) 60 that switches calls between the wireless telephones 34C, 44C (e.g. calling party wireless telephone) and telephones 34A,B, 44A,B connected to the PSTN. (refer to FIGS. 1 and 2).

Table 1 is a listing that provides an overview of the steps associated with providing incoming call notification and control options in accordance with a preferred embodiment of the present invention when a call is received on the subscriber's wireless telephone 34C.

The steps of Table 1 should be considered with reference to FIGS. 1 and 2 in order to maintain a visual perspective of the elements and the steps. Further, in the present description ANI is used to generically refer to a calling party number (i.e. caller ID), and DNIS is used to generically refer to a redirecting party number (i.e. the subscriber) and/or an actual terminating number since the ANI may not actual redirect calls, but may merely suspend process until further information received from another peripheral. Further, the term DN generically refers to the subscriber's landline phone number or the subscriber's wireless telephone number.

TABLE 1
(1) A subscriber 31 establishes a data connection to a data communications
service (DCS) 50, such as that provided by an Internet Service Provider
(ISP) or Commercial Online Service (COS).
(2) The subscriber 31, using a computer 35 (or generally any data
communications terminal-DCT such as an Internet appliance, Palm ™
handheld, etc.), modem 33 and a telephone link 36 connected to the
PSTN, connects to the DCS 50, which is connected to the public switched
telephone network through central office or CO 30, by dialing a
predetermined number.
(3) The subscriber 31 initiates a modem 33 call to the DCS 50 by instruct-
ing the computer 35 to dial the predetermined number.
(4) The subscriber's local central office (CO) 30 routes the call to the
number of the DCS 50 service point over a telephone link 52, which
connects the DCS 50 to the CO 30.
(5) The DCS 50 responds by accepting the call and going in an off hook
state thereby establishing a circuit 53 through CO 30.
(6) The modem 33 and computer 35 of the subscriber 31 and the DCS 50
negotiate a connection protocol and speed over a circuit 53 bridging the
subscriber telephone link 36 and a telephone link 52 of the DCS 50.
(7) Upon successful establishment of the connection protocol and speed
over circuit 53, the subscriber 31 is requested to enter user identification
and password information into the computer 35, which is communicated to
DCS 50.
(8) Upon entry of such information, the DCS 50 authenticates the
computer 35 of the subscriber 31 and if successful, the subscriber
computer 35 is granted access to the DCS 50.
(9) Immediately upon authentication of the subscriber provided informa-
tion, the access granted over the data connection is assigned either an
Internet Protocol (IP) address or other type of alphanumeric network
address identifier as so chosen by the DCS 50. A numerical address
identifier of either form is used to achieve successful routing of informa-
tion between the subscriber's computer 35 and the DCS 50.
(10) The subscriber's computer 35 transmits through the modem 33, by
way of the circuit 53, to the DCS 50 host by way of the dedicated
communications channel 54 a message to the Data Host (DH) 16 located at
the MTP 12, indicating that the subscriber's computer 35 has successfully
initiated a connection to the DCS 50. The message may contain a sub-
scriber identifier assigned the DCS in addition to the subscriber's network
address as assigned by the DCS 50.
(11) The DH 16 in turn transmits a message to the MTP 12 where it is
authenticated against an existing customer record file 26. If the subscriber
identifier is found in the customer record file 26 at the MTP 12, a message
is transmitted via the DCS 50 to the subscriber computer 35 indicating that
subscriber information was received and authenticated successfully.
(12) Then, in the event a telephone call is attempted to the subscriber's
wireless phone 34C, the CO 30 serving the subscriber's DN (i.e. the
number of the wireless/cellular phone) prepares to forward the call to call
busy forward dial number of the IVRS 14 by way of the PSTN and/or
from the cellular mobile telephone system (CMTS) via the cellular radio
switching office (CRSO) depending on the calling parties phone 44A or
44C.
(13) The CO 30 delivers, over signaling channel 10A, information about
the original destination of the call through a service known as Dialed
Number Identification Service (DNIS) as described above. The CO 30
may also deliver information identifying the origin of the call through a
service known as Automatic Number Identification (ANI). Both DNIS,
ANI and many variations therein are well known to those skilled in the art.
(14) Upon reception of DNIS and any supplied ANI information, and prior
to the IVRS 14 accepting the call, IVRS validates the DNIS information
against the subscriber records located in the customer record file 26 of the
MTP 12 to ensure that the
subscriber DN is a valid subscriber DN authorized to use the service. The
DN is also used to validate the existence of an active modem connection
between the subscriber computer 35 and the DCS 50.
(15) If the DNIS information is validated, the IVRS 14 transmits a
message over the signaling channel 10A to the CO 30 acknowledging and
accepting the call.
(16) If the existence of an active modem connection on circuit 53 was
established, concurrent with the presence of the call, the IVRS 14 delivers
to the MTP 12 notification that a call has been attempted to the sub-
scriber's 34C in addition to delivering the ANI of the caller's telephone
44A, C.
(17) The MTP 12, once again, validates the existence of a modem connec-
tion on circuit 53 between the subscriber and the DCS 50.
(18) If circuit 53 is still established, the MTP 12 sends a message by way
of the DH 16 to the subscriber computer 35 over the dedicated network
circuit bridging dedicated communications channels 18 and 54. This may
occur through one CO 30 or by way of a plurality of COs such as CO 30
and CO 42, which are coupled together by trunk 20 as illustrated in FIG.
1.
(19) Upon acceptance of the call, a voice path is established over tele-
phone link 10 between the caller's telephone 44A, B, C and the IVRS 14.
Alternatively, the IRVS 14 link to the PSTN can be dropped after call
connection.
(20) The IVRS 14, immediately upon acceptance of the call, delivers an
audio message to the caller's telephone 44A-C, which can optionally be
prerecorded by the subscriber.
(21) In the event the ANI information was not delivered from the CO 30,
or is not available, the IVRS 14 can produce an audio message audible
from caller's telephone 44A-C requesting the caller to input their origina-
ting telephone number using a touch-tone phone. The caller entry will
replace the previously absent ANI information.
(22) Upon delivery of the notification message to the subscriber computer
35, the subscriber software residing on the subscriber's computer 35,
notifies the subscriber 31 by way of visual and or audio notification. The
audio notification could include a tone signal while the visual notification
will include presentation of the ANI information as captured and delivered
by the IVRS 14.
(23) Upon presentation of the caller information, the subscriber 31 can
utilize a computer input device to select or input a response to be delivered
to the caller's telephone 44A-C. The input device used by the subscriber
31, in conjunction with the subscriber software, can select a number of
predefined options. Each option directly correlates to a specific identifier,
which is delivered to the DH 16.
(24) Upon successful receipt of the identifier by the DH 16, the DH 16
delivers the identifier to the MTP 12. The MTP 12 validates the identifier
and determines whether the identifier correlates to an audio message or to
a call handling instruction.
(25) In the event the identifier correlates to an audio message, a signal is
transmitted to the IVRS 14 from the MTP 12, which executes the delivery
of a specific audio file over the voice path to the caller which is a bridging
of telephone link 10 and telephone link 41 through CO 42 and 30
connected by trunk 20.
(26) If the identifier correlates to a call handling instruction, a signal is
transmitted to the IVRS 14, which redirects the voice path to a voice mail
system at the IVRS 14 or to another destination number on the PSTN.
(27) In the event the call handling instruction requires the voice path be
redirected to the directory number DN (either for phone 34A, B or wire-
less phone 34C) of the subscriber link 36 currently being utilized by the
subscriber computer 35 and modem 33, the voice path between the caller's
telephone 44A-C and the IVRS 14 is delayed from being redirected until
the DCS 50 transmits a message to the DH 16 indicating that modem 33
has disconnected from the DCS 50.

Reference is now made to FIG. 2, which shows a functional block diagram of the logical network elements interconnected with a called party proxy 38 that is advantageously employed to provide an audio interactive voice response to a calling party that attempts to call a subscriber whose wireless telephone 34C is not answered (e.g. busy, power off, not answered).

In the operation of a telephone system, a first caller to a subscriber's dial number is signaled to the subscriber by a ringing of the 34A or C. A ring tone is provided to the calling party to indicate ringing of the called party's handset. Where the subscriber is already using the telephone 34C, the second caller's telephone 44a is blocked and a blocking tone is provided to the second caller. This blocking tone is commonly referred to as a “busy signal” and advises the calling party that the called subscriber is using their telephone 34C (or is powered off).

Telephone service providers have enhanced the usability of the telephone system to provide a redirection (i.e. a call forward busy/no answer feature) to call placement within the telephone system providing an alternative to blocked calls as just described. Subscribers are provided the capability of directing callers to another telephone number (i.e. from wireless phone 34C to phone 34A) in the event that their number is busy or was not answered after a pre-selected number of rings.

When a caller using telephone 44a attempts to call a subscriber whose telephone 34C is busy, the caller is automatically redirected to a second subscriber provided telephone number served by telephone link 10. To employ the present invention, the subscriber can provide a call forward busy/no answer number that directs blocked calls or unanswered calls to their called party proxy connected to the PSTN by telephone link 10. As can be appreciated, the invention may be advantageously employed without any direct programming or installation by the telephone service provider other than to have the telephone service provider provide the capability of the “call forward busy/no answer” feature for the subscriber's telephone link.

When the call forward busy/no answer feature is enabled by a subscriber, any calls directed to that subscriber's telephone number are automatically routed to the alternate dial number selected by the subscriber when activating the call forward/busy/no answer feature. Thus, a subscriber can provide the dial number corresponding to their proxy when activating the call forward busy/no answer feature whereupon subsequent callers to their dial number will be automatically routed to the proxy without any further intervention from the subscriber and without any extra steps or intervention by the calling party.

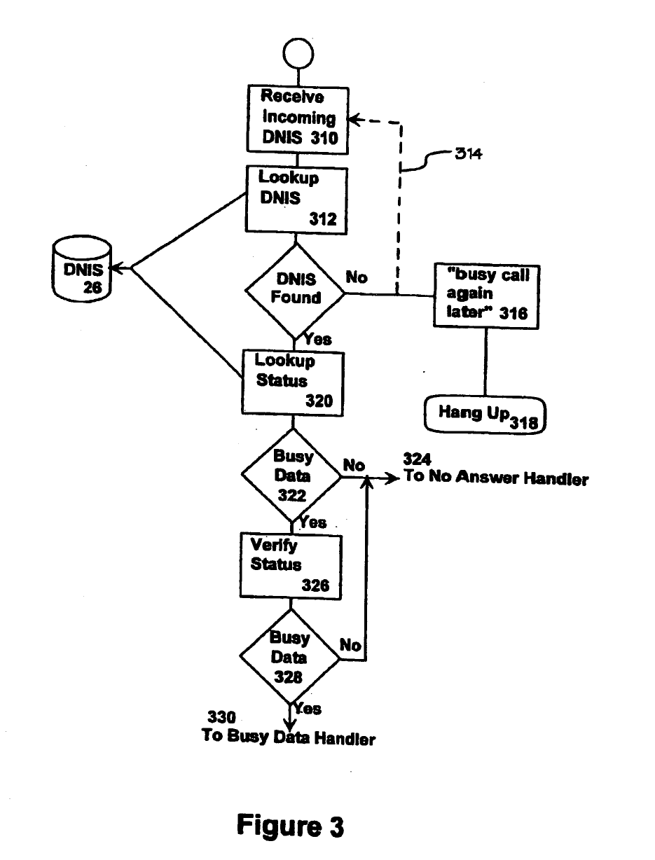

The IVRS, serving as a proxy for the subscriber, processes the incoming call in the manner generally set out in the flowchart of FIG. 3. The subscriber's dial number (e.g. the wireless telephone 34C number) is received as at 310 in accordance with the process for the Dialed Number Identification Service (DNIS). A lookup 312 of the dial number so obtained is made in the store of registered dial numbers contained within the customer record file 26 to determine if the subscriber is served by a proxy.

If there is no match, the call can be ignored, that is to say the link can be left to ring and ring without answer and the IVRS will simply wait for the next. incoming DNIS, as shown by the upward extending dashed line 314. Alternately, a no match call could be answered (that is, go off hook and establish a communications path with the caller) using a standard audio greeting to the effect that “the called number is busy or was not answered, please try again later” as shown in box 316. The IVRS would then hang up the link to disconnect the caller as shown at 318.

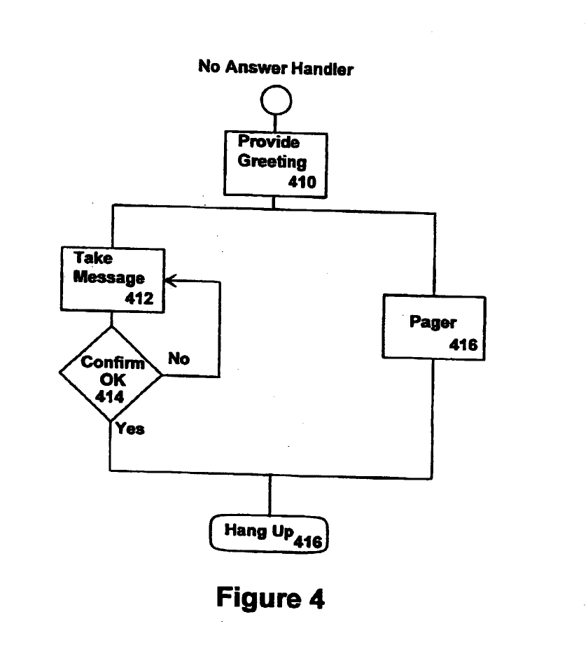

If the DNIS lookup was successful, then the IVRS next looks at the particulars of the information for the subscriber as at 320. In particular, it examines the BUSY DATA status field or register 322 which is a field set to YES when the subscriber that was called is engaged (or phone 34C powered off etc.). The BUSY DATA field is set to NO at all other times. If the BUSY DATA status field is set YES, this brings into play the additional call handling features to process the caller's call. It will be understood that the BUSY DATA status YES/NO can be represented in any suitable manner such as 1/0, Y/N or some other such equivalence.

Where the BUSY DATA status is NO, the subscriber is either talking on the telephone or wasn't there to answer the caller's incoming telephone call resulting in the call. In this case, indicated at 324, the proxy can process the call in the exemplary manner shown in FIG. 4. This call processing may be similar to an answering machine function and may simply provide a greeting as at 410 (“Hi, I'm on the phone or unable to take your call right now, please leave a massage . . . ”) and take a message 412 from the caller. The exemplary call processing flowchart of FIG. 4 has the additional optional step of interrogating the caller at the conclusion of the message to obtain confirmation that the caller is satisfied with the message and give the caller the opportunity to record a replacement message if the first was not satisfactory. This is shown at 414. Once the message has been taken, the telephone call is terminated by the proxy simply hanging up the link (ie go on hook) 416.

Optionally and by way of further example, the subscriber may have a pager service that could be accessible to callers. Where the subscriber has such a service, the caller may be greeted as at 410 and provided with the option to contact the subscriber via a pager (“Hi, I'm on the phone or unable to take your call right now, please leave a message to have me paged”). A pager contact process 416 for the caller is then initiated.

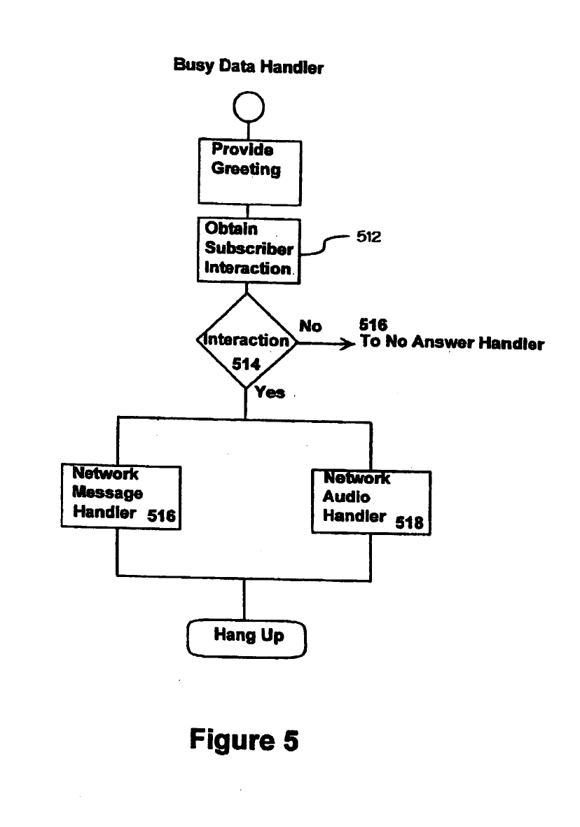

Referring again to FIG. 3, where the BUSY DATA status is YES, a status confirmation process 326 is preferably initiated to confirm that the subscriber is still engaged in the data dialogue. The proxy message transfer point initiates the confirmation process by having the proxy data handler send an enquiry message over the data network, such as the Internet, to the subscriber's computer. The subscriber's computer would automatically without user intervention prepare a response confirmation message for routing back to the proxy data handler. When the proxy data handler sends an enquiry data message, the response confirmation message must be received within a pre-selected time limit 328. This confirmatory process 326 and 328 is intended to ensure that the YES status wasn't simply left over from a previous computer dialogue session or otherwise in error. Confirmation of the BUSY DATA status results in a busy data handler process 330, which is described with reference to FIG. 5. In the event that the confirmatory process message exchanges did not successfully complete, the caller is routed to the Busy/No Answer process 324 previously described with reference to FIG. 4.

FIG. 5 provides a flowchart for the BUSY DATA process to which the caller is routed to when the called subscriber is active in a data use of the subscriber's telephone 34C (e.g. wireless phone 34C is used to itself connect to the Internet). In such a communications state, the blocked caller routed to the subscriber's proxy is now provided with many more options for contacting the subscriber. The proxy call handling process could now include not only the message and pager options for the caller described with reference to FIG. 4, but also delivery of notification messages to the subscriber to obtain interaction from the subscriber as shown at 512. The notification messages are delivered over the data network, such as the Internet, on a real time basis to the subscriber's computer.

The notification messages received at the subscriber's computer 35 can be acted upon by the subscriber's computer 35 in several different ways. The subscriber's computer 35 can process the notification message into a visually perceptible message for display on the subscriber's computer screen. The visually perceptible message indicates that a telephone caller has been routed to the proxy.

The subscriber's computer 35 can additionally process the notification message by initiating an audio notification aurally perceptible by the subscriber. The audio notification could be a simple ringing, chiming or tone signal and can be combined with the visually perceptible message.

Upon perception of the presence of a caller interacting with the subscriber's proxy, the subscriber can take one of several steps. The subscriber can take no action and the proxy data handler is not then able to provide the message transfer point with a subscriber response message as indicated at 514. The message transfer point will process the lack of notification of subscriber instructions from the subscriber's computer as an indication that the subscriber is not at that time interacting with the computer and is therefor unable to provide instructions or messages to the proxy for dealing with the caller. The proxy message transfer point will then default to the no answer handler as shown at 516 to take a message from the caller in the same fashion as described previously with reference to FIG. 4.

If the subscriber 31 does interact with the computer 35 to direct messages over the data network, such as the Internet, to the proxy data host, these will be acted upon by the proxy to provide audio messages instructing the caller. For example, the Subscriber 31 could decide to disconnect the computer 35 from the telephone 34C to free up the telephone 34C to receive incoming calls.

The subscriber 31 would interact with the computer 35 to input this intention to the computer 35, which would forward a message to that effect over the data network or Internet to the proxy as at 516.

Upon receipt of such a message, the proxy IVRS would provide an audio message to the caller, to the effect “I am going to free up my telephone line in just a few moments, please hang up this call and call again to speak to me directly”. Thus the caller would be able to initiate another call to the subscriber. Another more convenient and preferred method of handling the call would be to have the IVRS transfer the call from the caller to the subscriber when the subscriber's line is free.

This step can be done by having the IVRS 14 wait a pre-determined time, such as 15 seconds, to allow the subscriber time to disconnect and free up the line to receive the transferred called. Alternately, instead of the proxy waiting a predetermined time such as 15 seconds, the subscriber's computer 35 could be configured to repeatedly send notification messages to the proxy at short pre-determined time intervals, such as every 2 seconds. When the notification messages stop arriving at the proxy, that condition would indicate that the subscriber 31 has disconnected and is ready to accept transfer of the call.

In another option, the subscriber's computer 35 can be configured to include an voice audio input path such as a microphone 22 and voice audio output path such as headphones 24 or speakers connected to suitable equipment within the computer such as a sound card. To process voice signaling, the subscriber's computer 35 would also require an Internet telephone system program capable of delivering messages carrying digital message representations of a voice conversation over the Internet. Such software programs are available and include Webphone™ by way of example.

The proxy IVRS would be similarly equipped with the necessary software and hardware to interconnect the caller with the sound equipment of the proxy. The subscriber 31 could input commands into the computer 35 indicating an intention to carry out a telephone conversation over the Internet using the Webphone™ software and messages to that effect would be transmitted to the proxy to establish the necessary data path and interconnections as at 518 to have the caller bridged to the subscriber 31 over a message path capable of carrying a voice conversation between the caller and the subscriber 31 all without disconnecting the subscriber 31 from the data services being using. To inform the caller of the subscriber's intention to set up an audio bridge over the Internet, the proxy might provide an informational audio message to the caller to keep the caller on the telephone long enough for the necessary setups to occur. An example audio message produced by the proxy while the setup is occurring might be “Just a moment, while I set up my telephone to speak with you please”.

In summary, the present invention provides a method and system that provides a wireless telephone user with the capability of monitoring and managing calls (received from another wireless telephone or from a direct wired telephone) using the Internet. In particular, if the user's wireless telephone is off, on (but not answered), or in use then an incoming call notification is provided to the user in real-time via an Internet connection. The notification can be via a popup window that displays the calling party number, the calling party name, city and state/province information. The user, with this information, can answer the call (on the wireless telephone), transfer the call to another number, play back a prescribed message, transfer the call to a voice mail box, or ignore the call.

Industrial Applicability

The present invention as described above in the exemplary embodiments applies to the industrial field of wireless telephone call management.

1. A call management method for providing notification of calls, destined for a wireless telephone, over a data communications network having a call management proxy having a database of subscribers in communication with the data communications network, the method comprising the steps of:
(a) connecting a data communications terminal (DCT) to a network;
(b) providing a data network address of the DCT to the call management proxy; and
(c) notifying the DCT when an incoming call is detected on the wireless telephone.

2. The method of claim 1, wherein step (b) includes the step of notifying the call management proxy that the wireless telephone is to be monitored.

3. The method of claim 1, wherein step (c) includes the steps of receiving a call waiting message at the DCT corresponding to a telephone call to the wireless telephone and processing the call waiting message to produce an output perceptible by a person.

4. The method of claim 3, wherein the call waiting message includes caller identification information.

5. A call management method for providing notification of calls, destined for a wireless telephone, over a data communications network having a call management proxy, which contains a database of wireless telephone subscribers, in communication with the data communications network, the method comprising the steps of:
(a) enabling connection of a data communications terminal (DCT) to a network;
(b) requesting a data network address of the DCT to the call management proxy; and
(c) providing notification to the DCT when an incoming call is detected on the wireless telephone.

6. The method of claim 1, wherein step (b) includes the step of requesting from the DCT that the subscriber's wireless telephone is to be monitored.

7. The method of claim 1, wherein step (c) includes the steps of providing a call waiting message at said DCT corresponding to a telephone call to the wireless telephone and enabling processing of the call waiting message to produce an output perceptible by a person.

8. The method of claim 3, wherein the call waiting message includes caller identification information.

9. A call management method for providing notification of calls, destined for a wireless telephone, in a public switched telephone network (PSTN) and cellular mobile telephone system (CMTS) environment over a data communications network having a call management proxy, which includes a database of wireless telephone subscribers, connected to the PSTN and the CMTS, the method comprising the steps of:
(a) receiving a message over the data communications network containing a subscriber dial number linked to the wireless telephone and a unique data network address;
(b) storing the subscriber dial number and the unique data network address;
(c) receiving a telephone call forwarded by the CMTS;
(d) obtaining dialed number information from the CMTS;
(e) comparing the dialed number information to the stored subscriber dial number information; and
(f) for matching number information, providing a call waiting message to said data network addressed to said unique data network address corresponding to the dialed number information.

10. The method of claim 9, further including the step of receiving caller identification information from the PSTN and CSTM and including the caller identification in the call waiting message.
